(19) United States
(12) Patent Application Publication
(10) Pub. No.: US 2026/0063959 A1
(43) Pub. Date: Mar. 5, 2026

(54) HANDHELD ELECTRONIC DEVICE

(71) Applicant: HTC Corporation, Taoyuan City (TW)

(72) Inventors: Sheng-Le Wang, Taoyuan City (TW); Chung-Hsiang Chang, Taoyuan City (TW); Yueh-Ting Chung, Taoyuan City (TW)

(73) Assignee: HTC Corporation, Taoyuan City (TW)

(21) Appl. No.: 18/822,486

(22) Filed: Sep. 3, 2024

(51) Int. Cl. G02F 1/163; G02B 7/10; G02B 7/14; G02F 1/1516; G02F 1/157

(52) U.S. Cl. CPC G02F 1/163; G02B 7/10; G02B 7/14; G02F 1/15165; G02F 1/157

(57) ABSTRACT

A handheld electronic device includes a photosensitive element, a lens group, and a light beam adjustment element. The lens group receives a light beam and is disposed between the photosensitive element and the light beam adjustment element. When the light beam adjustment element is in an open state, the light beam passes through the light beam adjustment element and the lens group and is imaged on the photosensitive element. When the light beam adjustment element is in a closed state, a light transmittance of the light beam adjustment element is lower than a threshold.

### TECHNICAL FIELD

The invention relates to an electronic device, and in particular to a handheld electronic device.

### DESCRIPTION OF RELATED ART

As the public pays more attention to privacy, whether the privacy of others is violated must be taken note of when shooting with electronic products. Therefore, when shooting with electronic products, others need to know that the users of the electronic products are shooting and that others are being shot. The act of disclosure will be referred to as “shooting disclosure” in the following text.

In the past, the practice of shooting disclosure is usually to inform others through the indicator light on the shooting side or the sound prompt of the electronic devices. However, the indicator light may be easily circumvented via blocking the indicator light with a shield or by disassembling the indicator light circuit and adding a corresponding load (that is, the indicator light does not light up but shooting may actually be performed). The sound prompt is not suitable for recording with the electronic products (that is, there is no sound prompt during recording). Therefore, how to achieve the effect of shooting disclosure in a more intuitive and effective way is still a topic for relevant manufacturers who value privacy.

### SUMMARY OF INVENTION

The invention provides a handheld electronic device, so that a person being shot may directly know that he/she is in a shooting state, and shooting disclosure is difficult to be circumvented, effectively maintaining the privacy of the person being shot and preventing a photographer from infringing on the privacy of others.

According to an embodiment of the invention, a handheld electronic device includes a photosensitive element, a lens group, and a light beam adjustment element. The lens group is adapted to receive a light beam and is disposed between the photosensitive element and the light beam adjustment element. When the light beam adjustment element is in an open state, the light beam is imaged on the photosensitive element. When the light beam adjustment element is in a closed state, the light beam is prevented from being imaged on the photosensitive element, and a light transmittance of the light beam adjustment element is reduced.

Based on the above, when the handheld electronic device is shooting, the light beam adjustment element is opened. At this time, an image light beam of a person being shot may pass through the light beam adjustment element and be imaged on the photosensitive element to obtain a clear image. The person being shot may observe a lens outline (for example, the external outline of the lens group) of the handheld electronic device from the appearance of the handheld electronic device to know that the lens is opened at this time, and the person being shot may know that he/she is being shot to achieve shooting disclosure.

On the contrary, when the handheld electronic device is not shooting, the light beam adjustment element is closed. At this time, the image light beam of the person being shot cannot pass through the light beam adjustment element, and the photosensitive element cannot generate a clear image. The light transmittance of the light beam adjustment element is reduced, so the person being shot may observe that the lens of the handheld electronic device is obviously darkened, fogged, or changed in color from the appearance of the handheld electronic device to know that the photographer is not in the shooting state. In this way, the handheld electronic device of the embodiment may more intuitively inform others whether they are in the shooting state, and shooting disclosure cannot be circumvented via blocking the indicator light, eliminating the need for indicator light elements and power consumption thereof. In addition, when the light beam adjustment element is closed, the light beam adjustment element also prevents the photosensitive element from imaging, making it difficult for the photographer to circumvent shooting disclosure, so that the handheld electronic device effectively protects the privacy of the person being shot and prevents the photographer from infringing on the privacy of others.

In order for the features and advantages of the invention to be more comprehensible, the following specific embodiments are described in detail in conjunction with the drawings.

### BRIEF DESCRIPTION OF THE DRAWINGS

FIG. 1 is a schematic structural diagram of a handheld electronic device according to an embodiment of the invention.

FIG. 2A and FIG. 2B are schematic diagrams of optical principles of the handheld electronic device according to the embodiment of FIG. 1.

FIG. 2C and FIG. 2D are respectively schematic diagrams of changes in appearance of the handheld electronic device corresponding to FIG. 2A and FIG. 2B.

FIG. 3 is a schematic structural diagram of a handheld electronic device according to an embodiment of the invention.

FIG. 4A and FIG. 4B are schematic diagrams of optical principles of the handheld electronic device according to the embodiment of FIG. 3.

FIG. 4C and FIG. 4D are respectively schematic diagrams of changes in appearance of the handheld electronic device corresponding to FIG. 4A and FIG. 4B.

FIG. 5 is a schematic structural diagram of a handheld electronic device according to an embodiment of the invention.

FIG. 6A and FIG. 6B are schematic diagrams of optical principles of the handheld electronic device according to the embodiment of FIG. 5.

FIG. 6C and FIG. 6D are respectively schematic diagrams of changes in appearance of the handheld electronic device corresponding to FIG. 6A and FIG. 6B.

FIG. 7 is a schematic structural diagram of a handheld electronic device according to an embodiment of the invention.

FIG. 8 is a schematic structural diagram of a handheld electronic device according to an embodiment of the invention.

### DESCRIPTION OF THE EMBODIMENTS

As used herein, “about”, “approximately”, “essentially”, or “substantially” includes the stated value and an average value within an acceptable deviation range of the particular value as determined by persons skilled in the art, while taking into account the measurement in discussion and a particular amount of error (that is, the limitation of a measurement system) related to the measurement. For example, “about” may mean within one or more standard deviations or within, for example, ±30%, ±20%, ±15%, ±10%, or ±5% of the stated value. Furthermore, “about”, “approximately”, “essentially”, or “substantially” used herein may choose a more acceptable deviation range or standard deviation according to measurement properties, cutting properties, or other properties and may not apply one standard deviation to all properties.

In the drawings, the thicknesses of layers, films, panels, regions, etc., are exaggerated for clarity. It should be understood that when an element such as a layer, a film, a region, or a substrate is referred to as being “on” another element or “connected to” another element, the element may be directly on the other element or connected to the other element or there may be an intermediate element. In contrast, when an element is referred to as being “directly on” another element or “directly connected to” another element, there is no intermediate element. As used herein, “connection” may refer to physical and/or electrical connection. Furthermore, “electrical connection” may be that there is another element between two elements.

Reference will now be made in detail to the exemplary embodiments of the invention, and examples of the exemplary embodiments are illustrated in the drawings. Wherever possible, the same reference numerals are used in the drawings and the description to represent the same or similar parts.

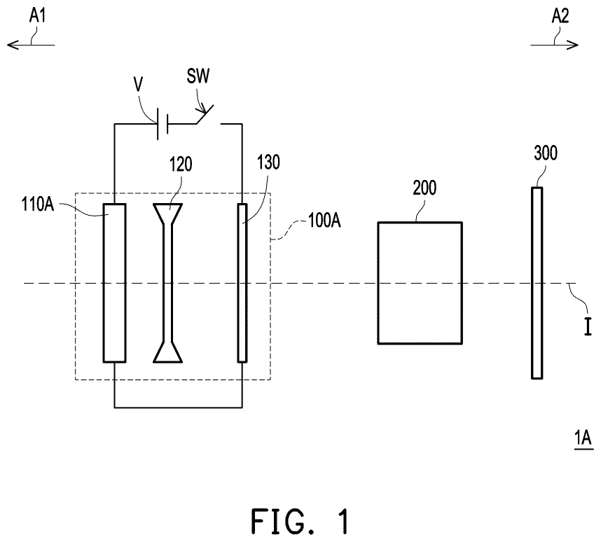

FIG. 1 is a schematic structural diagram of a handheld electronic device according to an embodiment of the invention. Please refer to FIG. 1. The invention provides a handheld electronic device 1A, which may be an electronic device having an imaging function, such as a smartphone, a digital camera, an identification device, or a video camera, and the invention is not limited thereto. The handheld electronic device 1A includes a light beam adjustment element 100A, a lens group 200, and a photosensitive element 300. In the embodiment, the handheld electronic device 1A may have an optical axis I, an object side A1, and an image side A2. The light beam adjustment element 100A, the lens group 200, and the photosensitive element 300 may all be disposed on the optical axis I and sequentially arranged from the object side A1 to the image side A2. In other words, the lens group 200 may be disposed on the object side A1 of the photosensitive element 300, and the lens group 200 is disposed between the photosensitive element 300 and the light beam adjustment element 100A. A light beam L emitted by an object (for example, an object being shot, a person being shot, or a sensing object) may enter the handheld electronic device 1A via the light beam adjustment element 100A, and then be transmitted to the photosensitive element 300 through the lens group 200 to form an image.

The lens group 200 may include multiple condensing lenses, astigmatism lenses, diaphragms, focusing elements, or fixing members (not shown). The material of each lens in the lens group 200 may be plastic or glass, and the invention is not limited thereto. The lens group 200 as a whole may have a positive refractive index to focus and image the light beam L on the photosensitive element 300, and the invention does not limit the type and the number of optical elements in the lens group 200. In other words, in the embodiment where the handheld electronic device 1A is a smartphone, the lens group 200 may be regarded as a lens module of the smartphone.

On the other hand, the photosensitive element 300 may be a charge-coupled device (CCD) or a complementary metal oxide semiconductor active pixel sensor (CMOS active pixel sensor) to convert the image formed by the light beam L into an electrical signal to be transmitted to a circuit or a memory (not shown) connected thereto for storage, transmission, or processing, and the invention is not limited thereto. In some embodiments, the photosensitive element 300 may also be a traditional film.

It is worth mentioning that the light beam adjustment element 100A may adjust the refractive index via electronic control, so as to control whether the light beam L may be clearly imaged on the photosensitive element 300. Specifically, when the light beam adjustment element 100A is in an open state, the light beam L is clearly imaged on the photosensitive element 300, and at this time, the light beam adjustment element 100A has normal light transmittance. When the light beam adjustment element 100A is in a closed state, the light beam L cannot be clearly imaged on the photosensitive element 300 (that is, defocused), and the light transmittance of the light beam adjustment element 100A is lower than a threshold.

Specifically, in the embodiment, the light beam adjustment element 100A also includes an electrochromic material 110A, a refractive lens group 120, and an electronically controlled zoom lens 130. The above elements may be sequentially disposed on the optical axis I from the object side A1 to the image side A2, but the invention is not limited thereto. In other embodiments not shown, based on the reversibility of light, the sequence of the refractive lens group 120 and the electronically controlled zoom lens 130 in the light beam adjustment element 100A may be appropriately replaced, as long as the optical effects thereof can be maintained. The electronically controlled zoom lens 130 may be a liquid lens whose refractive index is changed via an electrical signal, a liquid crystal lens whose refractive index is controlled via an electrical signal, or other optical lenses whose refractive indexes may be controlled via electrical signals known by persons skilled in the art, and the invention is not limited thereto. The refractive lens group 120 may be a single or multiple lenses with refractive indexes (for example, negative refractive indexes), and the invention is not limited thereto. The electrochromic material 110A may be, for example, a polymer-dispersed liquid crystal (PDLC), a suspended particle device (SPD), or other optical materials whose transmittance, color, or haze may be controlled via electrical signals known to persons skilled in the art, and the invention is not limited thereto. By the optical effects of the above elements, the light beam adjustment element 100A can achieve the control effect.

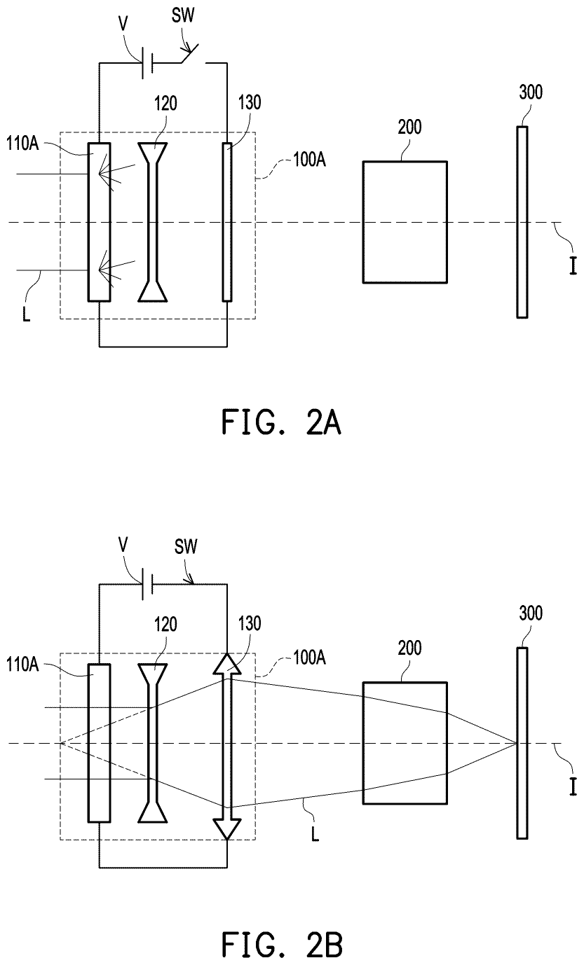

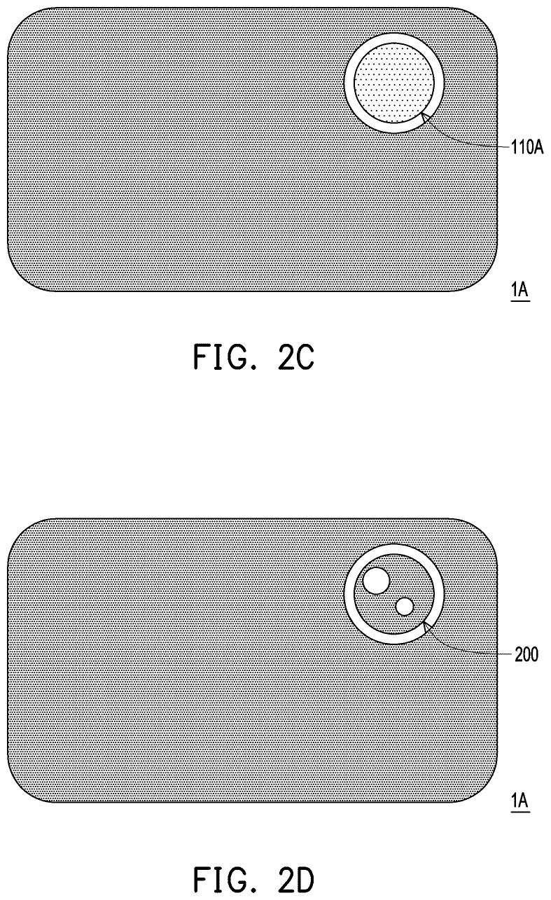

FIG. 2A and FIG. 2B are schematic diagrams of optical principles of the handheld electronic device according to the embodiment of FIG. 1. FIG. 2C and FIG. 2D are respectively schematic diagrams of changes in appearance of the handheld electronic device corresponding to FIG. 2A and FIG. 2B. The following will describe the working principle of the light beam adjustment element 100A. Please refer to FIG. 2A first. When the light beam adjustment element 100A is in the closed state, a switch SW is disconnected, causing the visible light transmittance of the electrochromic material 110A to decrease or the haze to increase (for example, the visible light transmittance becomes less than 5% and the haze becomes more than 95%), that is, the threshold of the light transmittance of the light beam adjustment element 100A may be 5% at this time. Of course, the invention is not limited thereto. As shown in FIG. 2C, at this time, others cannot observe the outline of the lens (for example, the outline of the lens group 200 cannot be observed) or the lens is obviously darkened in color or blurred due to the position being blocked by the electrochromic material 110A, so as to know that the lens is not opened, and others may also know that they are not being shot to know that their privacy is not violated. It should be noted that persons skilled in the art may choose the type of the corresponding electrochromic material 110A to choose an appropriate threshold, as long as the appearance of the light beam adjustment element 100A changes in color, transparency, or haze, so that others may observe that the outline of the lens group 200 is obviously darkened, and the lens group 200 cannot effectively receive the light beam L, so that the photosensitive element 300 cannot image.

Not only that, even if a small part of the light beam L passes through the electrochromic material 110A, the refractive index of the refractive lens group 120 disposed on the image side A2 of the electrochromic material 110A may further defocus the light beam L. Moreover, the electronically controlled zoom lens 130 at this time is not activated due to circuit disconnection, and the refractive index at this time may be substantially 0. For example, at this time, the sum of the refractive index of the electronically controlled zoom lens 130, the refractive index of the refractive lens group 120, and the refractive index of the lens group 200 may enable the imaging position of the light beam L to be away from the photosensitive element 300. Accordingly, the light beam L cannot be clearly imaged on the photosensitive element 300 even after passing through the refractive lens group 120, the electronically controlled zoom lens 130, and the lens group 200. Therefore, when the light beam adjustment element 100A is in the closed state, the handheld electronic device 1A cannot obtain a clear image of the person being shot, which can ensure that the user of the handheld electronic device 1A does not violate the privacy of others.

Please refer next to FIG. 2B and FIG. 2D. On the other hand, when a voltage source V is opened and the switch SW is conducted, so that the light beam adjustment element 100A is in the open state, the visible light transmittance of the electrochromic material 110A increases or the haze decreases (for example, the visible light transmittance becomes above 80%, and the haze becomes below 5%), and the appearance of the light beam adjustment element 100A becomes obviously transparent. As shown in FIG. 2D, at this time, others may observe the outline of the lens (for example, the outline of the lens group 200), so as to know that the lens is opened, and the person being shot may know that he/she is being shot to achieve the shooting disclosure.

On the other hand, at this time, the light beam L passes through the electrochromic material 110A, and the electronically controlled zoom lens 130 is activated due to enablement and has a refractive index (for example, a positive refractive index), so that the refractive index of the electronically controlled zoom lens 130 may partially offset or completely offset the refractive index (for example, a negative refractive index) of the refractive lens group 120. Accordingly, the sum of the refractive index of the electronically controlled zoom lens 130, the refractive index of the refractive lens group 120, and the refractive index of the lens group 200 may enable the imaging position of the light beam L to be substantially on an imaging plane of the photosensitive element 300. Therefore, when the light beam adjustment element 100A is in the open state, the handheld electronic device 1A may obtain a clear image of the person being shot.

Using the above manner, the handheld electronic device 1A does not need to be equipped with an indicator light, and the person being shot may know that he/she or she is in a shooting state in a more intuitive way (such as observing the lens), and the setting and the power consumption of the indicator light are eliminated. When the light beam adjustment element 100A is closed, the light beam L cannot be imaged on the photosensitive element 300, and the handheld electronic device 1A cannot circumvent shooting disclosure through blocking the indicator light or changing the circuit of the indicator light or it is difficult to circumvent shooting disclosure through disassembling the lens cover, thereby protecting the privacy of others.

Another embodiment will be exemplified below to describe the invention in detail, wherein the same components will be marked with the same numerals, and the description of the same technical content will be omitted. For the omitted part, please refer to the foregoing embodiment, which will not be described again. It should be noted that the following embodiments may be replaced, reorganized, and mixed with features in several different embodiments to complete other embodiments without departing from the spirit of the disclosure. Features in various embodiments may be mixed and matched as long as the features do not violate the spirit of the invention or conflict with each other.

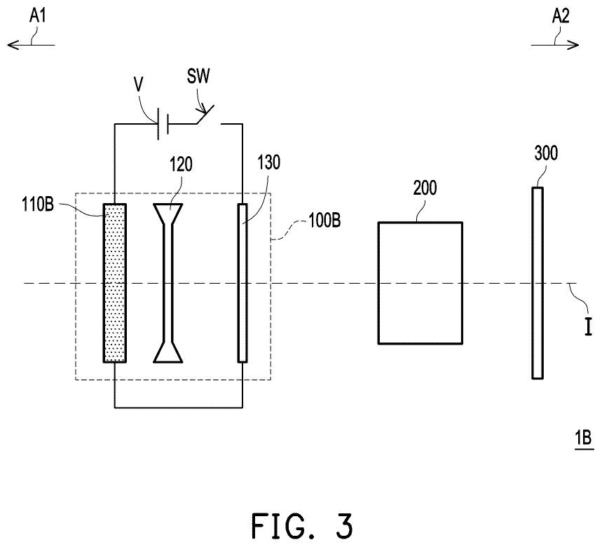

FIG. 3 is a schematic structural diagram of a handheld electronic device according to an embodiment of the invention. Please refer to FIG. 3. A handheld electronic device 1B of the embodiment is similar to the handheld electronic device 1A of FIG. 1. The main difference is that in a light beam adjustment element 100B of the handheld electronic device 1B, a electrochromic material 110B thereof also includes a dye liquid crystal.

For example, the dye liquid crystal of the electrochromic material 110B may be a mixture of liquid crystal molecules and dye molecules. The dye molecules may be dichroic. When the liquid crystal molecules change their arrangement, the dye molecules may also change their arrangement. Furthermore, deflection of the liquid crystal molecules may be controlled via an electrical signal to drive deflection of the dye molecules, so that the electrochromic material 110B may be in a dark state when in the closed state and in a bright state when in the open state. Based on the above, persons skilled in the art may adopt a conventional dye liquid crystal type as the electrochromic material 110B, and the invention is not limited thereto.

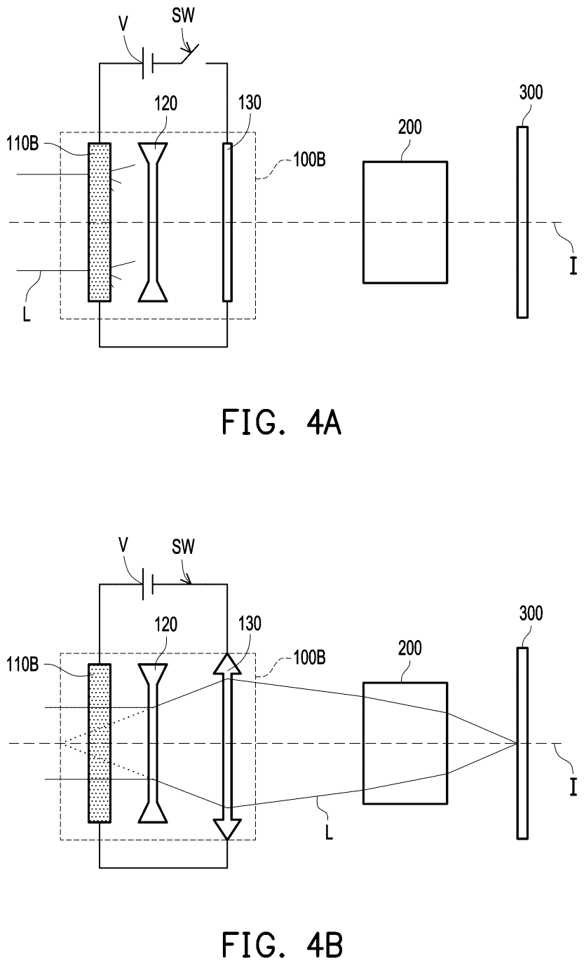

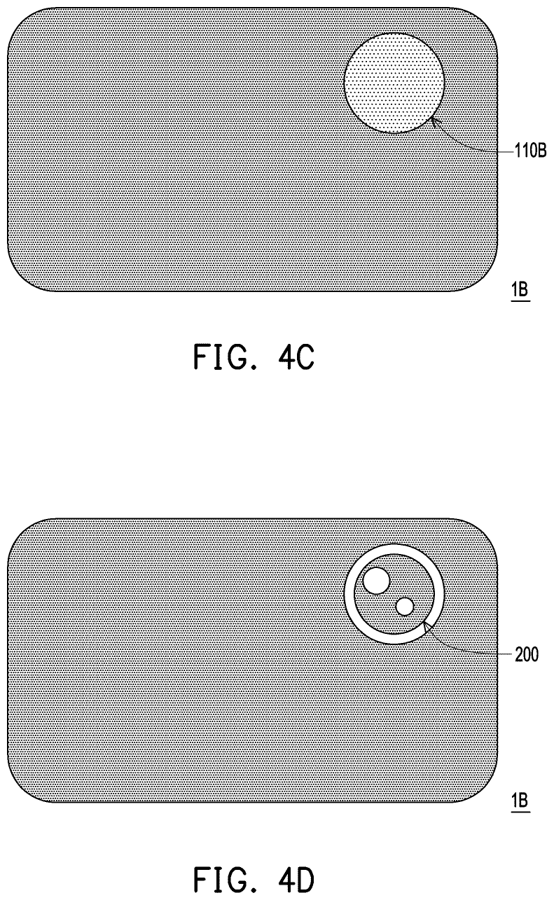

FIG. 4A and FIG. 4B are schematic diagrams of optical principles of the handheld electronic device according to the embodiment of FIG. 3. FIG. 4C and FIG. 4D are respectively schematic diagrams of changes in appearance of the handheld electronic device corresponding to FIG. 4A and FIG. 4B. Please refer to FIG. 4A and FIG. 4C first. Similar to the working principle of the handheld electronic device 1A of FIG. 2A, when the light beam L is transmitted to the light beam adjustment element 100B in the closed state, the electrochromic material 110B may be in the dark state and absorb most of the light beam L, as shown in FIG. 4C, at this time, others cannot observe the outline of the lens (for example, the outline of the lens group 200), so as to know that the lens is not opened, and others may also know that they are not being shot to know that their privacy is not violated.

Next, refer to FIG. 4B and FIG. 4D. On the other hand, when the light beam adjustment element 100B is in the open state, the switch SW is conducted, so that the electrochromic material 110B is opened and in the bright state, and the appearance of the light beam adjustment element 100B becomes obviously transparent. As shown in FIG. 4D, at this time, others may observe the outline of the lens (for example, the outline of the lens group 200), so as to know that the lens is opened, and the person being shot may know that he/she is being shot to achieve the shooting disclosure. For relevant technical means, please refer to the foregoing paragraphs, which will not be described again.

Accordingly, the handheld electronic device 1B may also achieve similar effects to the handheld electronic device 1A. Furthermore, due to the effect of the dye liquid crystal of the electrochromic material 110B, the color change is more obvious in the closed state. When in the open state, the dye liquid crystal is also deflected by the electric field. Therefore, although a very small amount of the energy of the light beam L is absorbed, the influence is not significant.

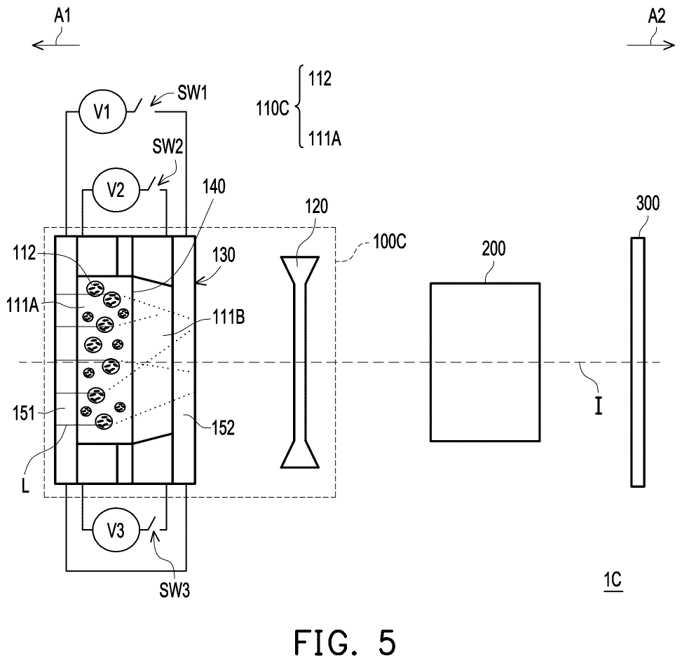

FIG. 5 is a schematic structural diagram of a handheld electronic device according to an embodiment of the invention. Please refer to FIG. 5. A handheld electronic device 1C of the embodiment is similar to the handheld electronic device 1A of FIG. 1. The main difference is that the structure of a light beam adjustment element 100C of the handheld electronic device 1C is slightly different. Specifically, an electrochromic material 110C of the light beam adjustment element 100C is disposed in the electronically controlled zoom lens 130. In addition, the electrically controlled zoom lens 130 includes a first dielectric layer 111A, a second dielectric layer 111B, and a piezoelectric material 140. The first dielectric layer 111A is disposed on one side (that is, the object side A1) away from the photosensitive element 300 in the electronically controlled zoom lens 130, the second dielectric layer 111B is disposed on one side (that is, the image side A2) close to the photosensitive element 300 in the electronically controlled zoom lens 130, and the piezoelectric material 140 is disposed between the first dielectric layer 111A and the second dielectric layer 111B. On the other hand, the refractive lens group 120 is disposed between the electronically controlled zoom lens 130 and the lens group 200.

The first dielectric layer 111A and the second dielectric layer 111B may have different refractive indexes and are disposed in the electronically controlled zoom lens 130 via a transparent substrate 151, a transparent substrate 152, and a seal (not shown). In the embodiment, the electrochromic material 110C may include a first dielectric layer 111A and a dispersed liquid crystal 112. On the other hand, the transparent substrate 151 and the transparent substrate 152 may have patterned transparent conductive layers (for example, ITO, not shown) and provide electrical signals via an externally connected voltage source V1. When the voltage source V1 is activated and the switch SW1 is conducted, an electric field may be generated between the transparent substrate 151 and the transparent substrate 152 to drive the dispersed liquid crystal 112 of the electrochromic material 110C to deflect, so that the refractive index of the dispersed liquid crystal 112 changes. In detail, when no voltage is applied, the dispersed liquid crystal 112 is randomly arranged, and the effective refractive index of the dispersed liquid crystal 112 is different from the refractive index of the first dielectric layer 111A with a polymer material. Therefore, when the light beam L is incident on the electrochromic material 110C, it is equivalent to having many interfaces in the electrochromic material 110C, so that the light beam L is severely scattered, thus forming a scattered state (also referred to as an opaque state or an off state), causing the electrochromic material 110C to have a foggy white appearance or an off-white appearance. However, when the voltage source V1 is activated and the switch SW1 is conducted, an electric field is generated between the transparent substrate 151 and the transparent substrate 152, and the dispersed liquid crystal 112 is arranged perpendicular to light incident surfaces of the transparent substrate 151 and the transparent substrate 152. At this time, the effective refractive index of the dispersed liquid crystal 112 is substantially the same as the refractive index of the first dielectric layer 111A, and the incident light beam L does not have an interface in the mixture of the dispersed liquid crystal 112 and the first dielectric layer 111A, so the electrochromic material 110C forms the bright state or a transparent state (an on state).

On the other hand, the piezoelectric material 140 may control the shapes or the curvatures of the first dielectric layer 111A and the second dielectric layer 111B via the activation and the conduction of a voltage source V2 and a switch SW2 and a voltage source V3 and a switch SW3. In this way, the refractive index of the electronically controlled zoom lens 130 may be controlled to determine whether the light beam L may be imaged in the photosensitive element 300 when the light beam adjustment element 100C is in the open state or the closed state.

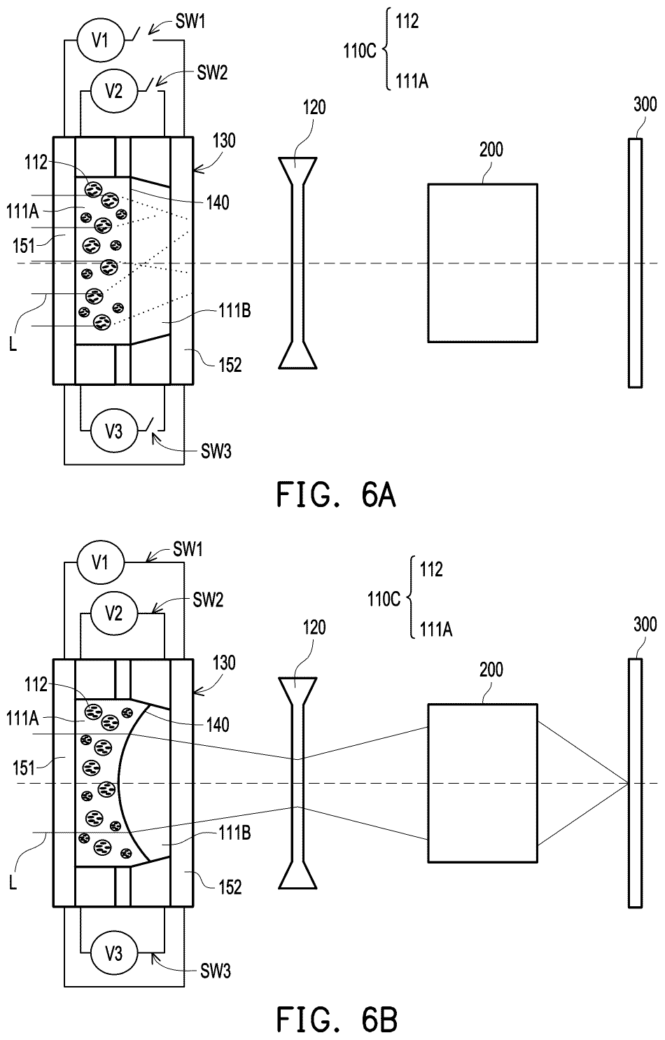

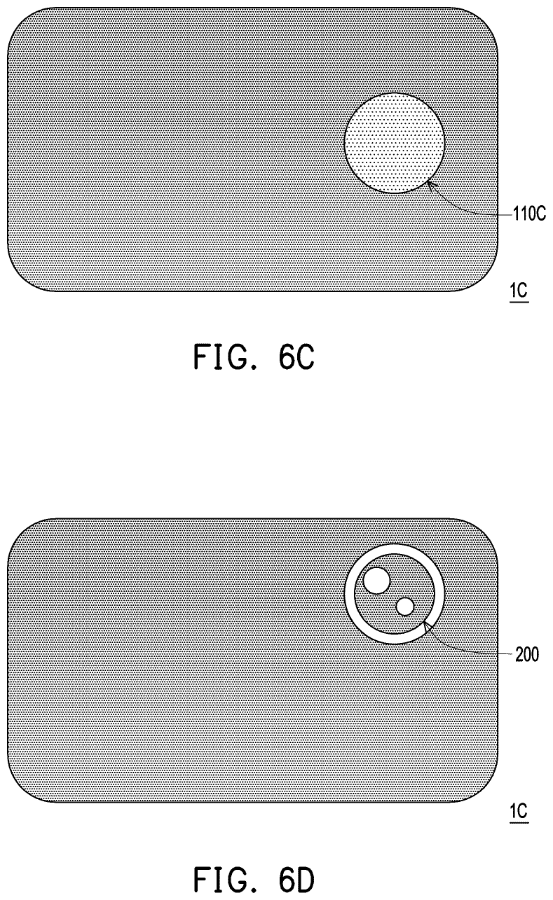

FIG. 6A and FIG. 6B are schematic diagrams of optical principles of the handheld electronic device according to the embodiment of FIG. 5. FIG. 6C and FIG. 6D are respectively schematic diagrams of changes in appearance of the handheld electronic device corresponding to FIG. 6A and FIG. 6B. The following will describe the working principle of the light beam adjustment element 100C. Please refer to FIG. 6A and FIG. 6C first. When the light beam adjustment element 100C is in the closed state, the switch SW1, the switch SW2, and the switch SW3 are disconnected, causing the visible light transmittance of the electrochromic material 110C to decrease or the haze to increase, and the appearance of the light beam adjustment element 100C significant changes in color, transparency, or haze. As shown in FIG. 6C, at this time, others cannot observe the outline of the lens (for example, the outline of the lens group 200 cannot be observed) or the lens is obviously darkened in color or blurred due to the position being blocked by the electrochromic material 110C, so as to know that the lens is not opened, and others may also know that they are not being shot to know that their privacy is not violated.

Not only that, even if a small part of the light beam L passes through the electrochromic material 110C, since the piezoelectric material 140 is not activated and does not bend at this time, the overall refractive index of the electronically controlled zoom lens 130 may be substantially 0. The refractive lens group 120 disposed on the image side A2 of the electronically controlled zoom lens 130 may further defocus the light beam L. For example, at this time, the sum of the refractive index of the electronically controlled zoom lens 130, the refractive index of the refractive lens group 120, and the refractive index of the lens group 200 may enable the imaging position of the light beam L to be away from the photosensitive element 300. Accordingly, the light beam L cannot be clearly imaged on the photosensitive element 300 even after passing through the refractive lens group 120, the electronically controlled zoom lens 130, and the lens group 200. Therefore, when the light beam adjustment element 100C is in the closed state, the handheld electronic device 1C cannot obtain a clear image of the person being shot, which can ensure that the user of the handheld electronic device 1C does not violate the privacy of others.

Please refer next to FIG. 6B and FIG. 6D. On the other hand, when the voltage source V1, the voltage source V2, and the voltage source V3 are opened, and the switch SW1, the switch SW2, and the switch SW3 are conducted, so that the light beam adjustment element 100C is in the open state, the visible light transmittance of the electrochromic material 110C increases or the haze decreases, and the appearance of the light beam adjustment element 100C becomes obviously transparent. As shown in FIG. 6D, at this time, others may observe the outline of the lens (for example, the outline of the lens group 200), so as to know that the lens is opened, and the person being shot may know that he/she is being shot to achieve the shooting disclosure.

On the other hand, at this time, the light beam L passes through the electrochromic material 110C and the piezoelectric material 140 is enabled and bent, causing the curvatures of the first dielectric layer 111A and the second dielectric layer 111B to change, so that the electronically controlled zoom lens 130 as a whole has a refractive index (for example, a positive refractive index). The refractive index of the electronically controlled zoom lens 130 may partially or completely offset the refractive index (for example, a negative refractive index) of the refractive lens group 120. Accordingly, the sum of the refractive index of the electronically controlled zoom lens 130, the refractive index of the refractive lens group 120, and the refractive index of the lens group 200 may enable the imaging position of the light beam L to be substantially on the imaging plane of the photosensitive element 300. Therefore, when the light beam adjustment element 100C is in the open state, the handheld electronic device 1C may obtain a clear image of the person being shot.

Accordingly, the handheld electronic device 1C may also achieve similar effects to the handheld electronic device 1A. Not only that, since the electrochromic material 110C is disposed in the electronically controlled zoom lens 130, it is more difficult for a person with ulterior motive to disassemble or de-solder the circuit of the light beam adjustment element 100C to circumvent the function of shooting disclosure of the handheld electronic device 1C, effectively protecting the privacy of bystanders or the person being shot.

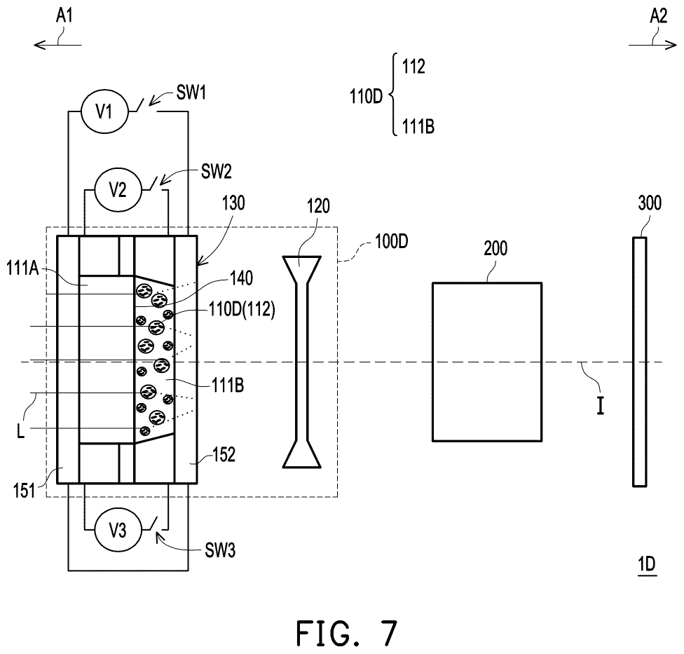

FIG. 7 is a schematic structural diagram of a handheld electronic device according to an embodiment of the invention. Please refer to FIG. 7. A handheld electronic device 1D of the embodiment is similar to the handheld electronic device 1C of FIG. 5. The main difference is that the position of the electrochromic material is different. Specifically, in a light beam adjustment element 100D of the handheld electronic device 1D, an electrochromic material 110D includes a second dielectric layer 111B and the dispersed liquid crystal 112. In other words, the electrochromic material 110D of the handheld electronic device 1D is disposed on the image side A2 of the piezoelectric material 140. In the embodiment, when no voltage is applied, the effective refractive index of the dispersed liquid crystal 112 is different from the refractive index of the second dielectric layer 111B with a polymer material. When the voltage source V1 is activated and the switch SW1 is conducted, an electric field is generated between the transparent substrate 151 and the transparent substrate 152, and the dispersed liquid crystal 112 is arranged perpendicular to the light incident surfaces of the transparent substrate 151 and the transparent substrate 152. At this time, the effective refractive index of the dispersed liquid crystal 112 is substantially the same as the refractive index of the second dielectric layer 111B. Accordingly, the electrochromic material 110D may also achieve the effect of the electrochromic material 110C, so that the handheld electronic device 1D may also achieve similar functions to the handheld electronic device 1C. For relevant paragraphs, please refer to the foregoing and FIG. 6A to FIG. 6D, which will not be described again.

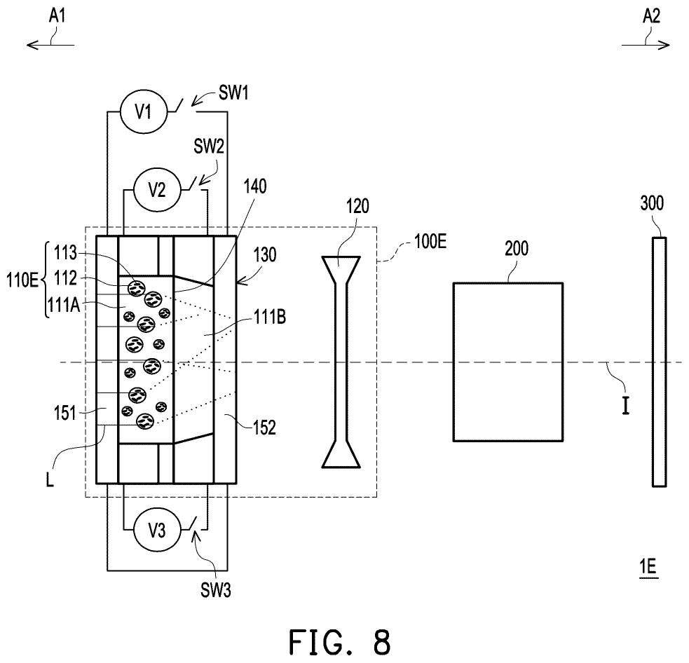

FIG. 8 is a schematic structural diagram of a handheld electronic device according to an embodiment of the invention. Please refer to FIG. 8. A handheld electronic device 1E of the embodiment is similar to the handheld electronic device 1C of FIG. 5. The main difference is that an electrochromic material 110E of a light beam adjustment element 100E of the embodiment also includes a dye liquid crystal 113. Accordingly, similar to the above effects of the handheld electronic device 1B and the handheld electronic device 1C, the electrochromic material 110E of the light beam adjustment element 100E may have a more light-absorbing function and the function of shooting disclosure, and the change in appearance is more obvious to help with the shooting disclosure of the user. For relevant paragraphs, please refer to the foregoing paragraphs, which will not be described again.

In summary, when the handheld electronic device is shooting, the light beam adjustment element is opened. At this time, an image light beam of the person being shot may pass through the light beam adjustment element and be imaged on the photosensitive element to obtain a clear image. The person being shot may observe a lens outline (for example, the external outline of the lens group) of the handheld electronic device from the appearance of the handheld electronic device to know that the lens is opened at this time, and the person being shot may know that he/she is being shot to achieve shooting disclosure.

On the contrary, when the handheld electronic device is not shooting, the light beam adjustment element is closed. At this time, the image light beam of the person being shot cannot pass through the light beam adjustment element, and the photosensitive element cannot generate a clear image. The light transmittance of the light beam adjustment element is lower than the threshold, so the person being shot may observe that the lens of the handheld electronic device is obviously darkened, fogged, or changed in color from the appearance of the handheld electronic device to know that the photographer is not in the shooting state. In this way, the handheld electronic device of the embodiment may more intuitively inform others whether they are in the shooting state, and shooting disclosure cannot be circumvented via blocking the indicator light, eliminating the need for indicator light elements and power consumption thereof. In addition, when the light beam adjustment element is closed, the light beam adjustment element also prevents the photosensitive element from imaging, making it difficult for the photographer to circumvent shooting disclosure, so that the handheld electronic device effectively protects the privacy of the person being shot and prevents the photographer from infringing on the privacy of others.

Although the invention has been disclosed in the above embodiments, the embodiments are not intended to limit the invention. Persons skilled in the art may make some changes and modifications without departing from the spirit and scope of the invention. Therefore, the protection scope of the invention shall be defined by the appended claims.

What is claimed is:

1. A handheld electronic device, comprising:
a photosensitive element;
a lens group, receiving a light beam and disposed on one side of the photosensitive element; and
a light beam adjustment element, wherein the lens group is disposed between the photosensitive element and the light beam adjustment element,
wherein when the light beam adjustment element is in an open state, the light beam passes through the light beam adjustment element and the lens group and is imaged on the photosensitive element, and when the light beam adjustment element is in a closed state, a light transmittance of the light beam adjustment element is lower than a threshold.

2. The handheld electronic device according to claim 1, wherein the light beam adjustment element further comprises an electrochromic material, a refractive lens group, and an electronically controlled zoom lens,
wherein when in the open state, the electrochromic material allows the light beam to pass through, and a sum of a refractive index of the electronically controlled zoom lens, a refractive index of the refractive lens group, and a refractive index of the lens group enables an imaging position of the light beam to be substantially on the photosensitive element;
wherein when in the closed state, the electrochromic material does not allow the light beam to pass through, and a sum of a refractive index of the electronically controlled zoom lens, a refractive index of the refractive lens group, and a refractive index of the lens group enables an imaging position of the light beam to be away from the photosensitive element.

3. The handheld electronic device according to claim 2, wherein the electronically controlled zoom lens comprises a liquid lens or a liquid crystal lens.

4. The handheld electronic device according to claim 2, wherein the electrochromic material comprises a dispersed liquid crystal.

5. The handheld electronic device according to claim 2, wherein the electrochromic material comprises a dye liquid crystal.

6. The handheld electronic device according to claim 2, wherein positions of the refractive lens group and the electronically controlled zoom lens are interchangeable.

7. The handheld electronic device according to claim 2, wherein the electronically controlled zoom lens further comprises:
a first dielectric layer, disposed on one side of the electronically controlled zoom lens away from the photosensitive element;
a second dielectric layer, disposed on one side of the electronically controlled zoom lens close to the photosensitive element; and
a piezoelectric material, disposed between the first dielectric layer and the second dielectric layer,
wherein the electrochromic material is disposed in the electronically controlled zoom lens, and the refractive lens group is disposed between the electronically controlled zoom lens and the lens group.

8. The handheld electronic device according to claim 7, wherein the electrochromic material further comprises a dye liquid crystal.

9. The handheld electronic device according to claim 7, wherein the electrochromic material comprises the first dielectric layer and a dispersed liquid crystal.

10. The handheld electronic device according to claim 7, wherein the electrochromic material comprises the second dielectric layer and a dispersed liquid crystal.
